(19) United States
(12) Patent Application Publication
(10) Pub. No.: US 2006/0001777 A1
(43) Pub. Date: Jan. 5, 2006

(54) Video signal output device

(75) Inventor: Shoji Araki, Honjo-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/170,741

(22) Filed: Jun. 30, 2005

(30) Foreign Application Priority Data
Jun. 30, 2004 (JP) 2004-194568

(51) Int. Cl. H04N 7/16; H04N 11/00

(52) U.S. Cl. 348/706; 348/552; 725/151

(57) ABSTRACT

A video signal output device comprises a signal processing unit which converts video and audio signals input via two signal paths to a time-division multiplex serial signal and outputs it, a changeover switch which has a plurality of output terminals and outputs the serial signal input from the signal processing unit through one of the output terminals which is selected according to a control signal, a plurality of digital interface terminals each of which is connected to a respective one of the output terminals of the changeover switch, and a control unit responsive to a command input from a user interface to supply the changeover switch with the control signal to select one of the output terminals to which the serial signal is output.

### CROSS-REFERENCE TO RELATED APPLICATIONS

This application is based upon and claims the benefit of priority from prior Japanese Patent Application No. 2004-194568, filed Jun. 30, 2004, the entire contents of which are incorporated herein by reference.

### BACKGROUND OF THE INVENTION

1. Field of the Invention

The present invention relates to a video signal output device which outputs video and audio signals through digital interface terminals.

2. Description of the Related Art

Conventional video output devices, such as video tape recorders, output video and audio signals in analog form.

In recent years, set-top boxes, such as DVD players and digital satellite broadcasting tuners, have been developed which output signals in digital form through digital interfaces, such as HDMI. Also, equipment which permits multimedia communications concurrently has been developed (see Japanese Unexamined Patent Publication No. 9-224081).

Digital video output devices are equipped with only one digital interface (such as HDMI) output system and hence have only one output terminal for the digital interface.

A problem is encountered in trying to use a digital video signal from the digital video output device with two or more domestic digital devices. That is, in reproducing an output video signal from the digital video output device on a television receiver or recording it on a DVD recorder, it is required to replace a cable for the interface with the digital. video output device with another.

### BRIEF SUMMARY OF THE INVENTION

According to the present invention, there is provided a video signal output device comprising: a signal processing unit which converts video and audio signals input via two signal paths to a time-division serial signal and outputs it; an output selection unit which has a plurality of output terminals and outputs the serial signal input from the signal processing unit through one of the output terminals which is selected according to a control signal; a plurality of digital interface terminals each of which is connected to a respective one of the output terminals of the output selection unit; and a control unit responsive to a command input from a user interface to supply the output selection unit with the control signal to select one of the output terminals to which the serial signal is output.

The video signal output device can supply various domestic digital devices with digital video signals without replacing an interfacing cable with another.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a video signal output device to which the principles of the present invention are applied;

FIG. 2 shows the manner in which video data and audio data are transferred through HDMI;

FIG. 3 is a block diagram of the output controller shown in FIG. 1; and

FIG. 4 is a flowchart illustrating the operation of the embodiment of the present invention.

### DETAILED DESCRIPTION OF THE INVENTION

An embodiment of the present invention will be described hereinafter with reference to the accompanying drawings.

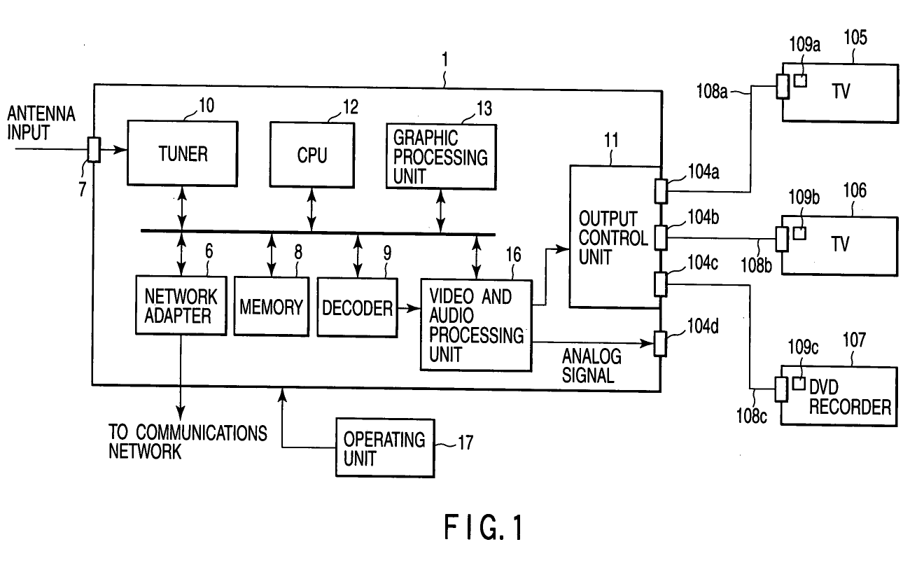

FIG. 1 is a block diagram of a video signal output device to which the principles of the present invention are applied. The video signal output device 1 is a set-top box (STB) (e.g., a digital satellite broadcast receiver).

The video signal output device, indicated generally at 1, is equipped with a network adapter 6, a digital broadcast signal input terminal 7, a memory 8, a decoder 9, a tuner 10, an output control unit 11, a CPU 12, a graphics processing unit 13, HDMI output terminal 104a, 104b and 104c, an analog signal output terminal 104d, a video and audio signal processing unit 16, and an operating unit 17.

The input terminal 7 is connected to receive broadcast signals received by an antenna. The tuner 10 extracts a transport stream (TS) of specific program information from digital broadcast signals from the input terminal 7. The decoder 9 decodes the extracted TS to output two signals: that is, a video signal and an audio signal, each of which is made up of a plurality of bits. The tuner 10 and the decoder 9 form signal producing means for producing decoded video and audio signals.

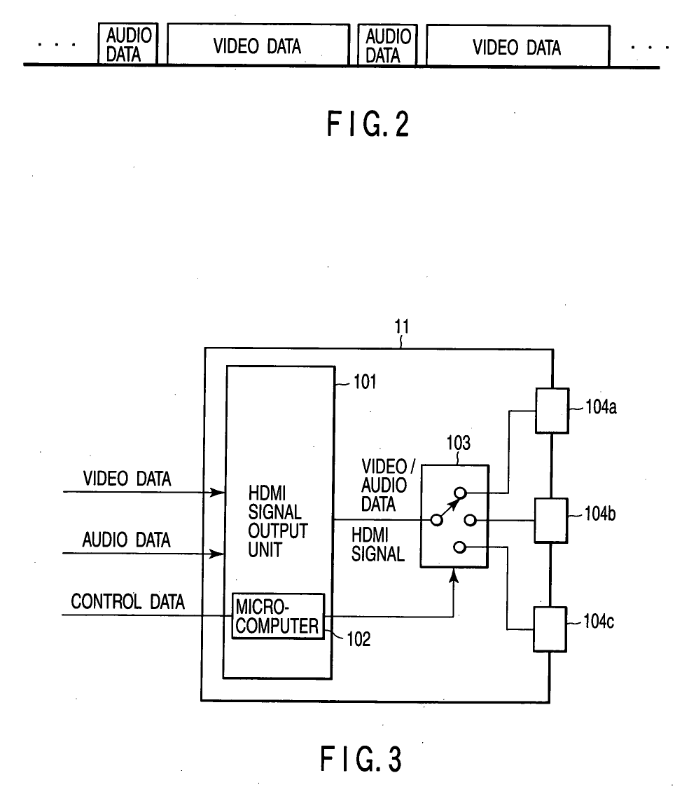

The video and audio signal processing unit 16 converts the program video signal decoded by the decoder 9 to a signal compatible to video equipment to which the video signal is output, such as a television receiver 105. The video and audio signal processing unit 16 converts each of the decoded program video and audio signals to an analog signal and then applies it to the analog signal output terminal 104d. An analog video signal and an analog audio signal are applied all the time to the analog signal output terminal 104d so long as the tuner 10 receives program information. The output control unit 11 converts two input signals, i.e., a video signal and an audio signal, to a time-division serial signal, i.e., an HDMI signal, and then transmits the resulting signal through one of the output terminals 104a, 104b, and 104c. In the HDMI, digital video data and digital audio data are transferred serially on a time division multiplex basis as shown in FIG. 2.

The operating unit 17 is a user interface equipped with various keys which accept a variety of input operations, for example, a remote controller. The CPU 12 responds to input signals from the operating unit 17 to control the components in the video signal output device 1. The memory 8 includes a ROM storing a program according to the present invention and a RAM used as a working area for the CPU 12. The graphics processing unit 13 produces on-screen display (OSD) images when necessary. The network adapter 6 provides the interface to a communications network.

The output control unit 11 will be described next with reference to FIG. 3.

The output control unit 11 has an HDMI signal output unit 101, a changeover switch 103, and HDMI output terminals 104a, 104b, and 104c. The HDMI signal output unit 101 converts video and audio signals transferred over two signal paths from the video and audio processing unit 16 to a serial signal of video data and audio data as shown in FIG. 2. The HDMI signal output unit 101 is comprised of an integrated circuit such as an LSI. The video and audio processing unit 16 and the HDMI signal output unit 101 may be fabricated as one LSI.

A microcomputer 102 changes over the switch 103 when commanded by the CPU 12. Thereby, the serial video/audio signal output from the HDMI signal output unit 101 is output from one of the HDMI output terminals 104a, 104b, and 104c. The HDMI output terminals 104a, 104b and 104c are connected to video devices 105, 106 and 107 by HDMI dedicated cables 108a, 108b and 108c, respectively.

Signal lines which connect the HDMI signal output unit 101, the changeover switch 103, and the output terminals 104a to 104c include signal lines to transmit an extended display identification data (EDID) signal and so on in addition to a signal line to transmit the serial video/audio signal. The EDID is data used for the display side (e.g., the television receiver 105) to cause the host side (the video signal output device 1) to recognize information on the display side (resolution, the number of pixels, etc.). The video devices 105, 106 and 107 have EDID memories 109a, 109b and 109c, respectively. Each of the video devices stores its own EDID in its EDID memory. The micro-computer 102 reads in the EDID of the video devices 104a, 104b and 104c connected to the output terminals 104a, 104b and 104c via the changeover switch 103 and holds the EDID. The video and audio processing unit 16 processes video data on the basis of user-specified video device EDID. Thus, video data output from the HDMI signal output unit 101 is made compatible with the video device to which it is output.

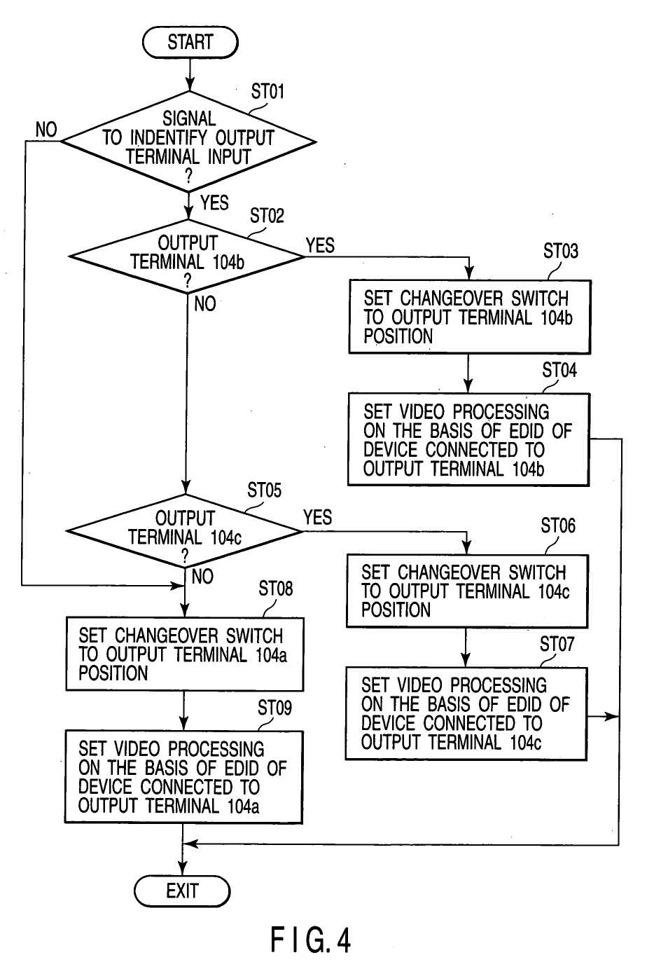

FIG. 4 is a flowchart illustrating the operation of the embodiment described above.

The CPU 12 makes a decision of whether a signal to identify one of the HDMI output terminals 104a, 104b and 104c has been input from the user via the operating unit 17 (step ST01). If such a signal has been input (YES in step ST01) and it indicates the output terminal 104b (YES in step ST02), the CPU 12 commands the microcomputer 102 to set the changeover switch 105 to the output terminal 104b position. The CPU then sets processing in the video and audio processing unit 16 to conform to the EDID of the video device 106 connected to the output terminal 104b. Thereby, the video and audio processing unit 16 is allowed to produce the optimum video signal for the television receiver 106.

If the signal indicates the output terminal 104c (YES in step ST05) but not the output terminal 104b (NO in step ST02), the CPU 12 commands the microcomputer 102 to set the changeover switch 103 to the output terminal 104c position (step ST06). The CPU then sets the processing in the video and audio processing unit 16 on the basis of the EDID of the video device 107 connected to the output terminal 104c (step ST07).

If the signal does not indicate the output terminal 104c (NO in step ST05) or no signal to identify one of the output terminals 104a to 104c is input (NO in step ST01), the CPU 12 commands the microcomputer 102 to set the changeover switch 103 to the output terminal 104a position (step ST08). The CPU then sets processing in the video and audio processing unit 16 to conform to the EDID of the video device 105 connected to the output terminal 104a (step ST09). Thereby, the video and audio processing unit 16 is allowed to produce the optimum video signal for the television receiver 105. For example, even if the television receivers 105 and 106 differ in resolution or aspect ratio, each of them is allowed to receive the optimum video signal.

Thus, according to this embodiment, signals output from the HDMI signal output unit 101 are output externally from two or more HDMI output terminals via the changeover switch 103. Accordingly, video signals can be applied to various digital video devices without replacing an interfacing cable with another. In addition, video and audio signals can be applied to two or more video devices using one HDMI signal processing LSI; thus, an increase in the cost of the video output device can be prevented in comparison with the case where two or more HDMI signal processing LSIs are used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video signal output device comprising:
a signal processing unit which converts video and audio signals input via two signal paths to a time-division serial signal and outputs it;
an output selection unit which has a plurality of output terminals and outputs the serial signal input from the signal processing unit through one of the output terminals which is selected according to a control signal;
a plurality of digital interface terminals each of which is connected to a respective one of the output terminals of the output selection unit; and
a control unit responsive to a command input from a user interface to supply the output selection unit with the control signal to select one of the output terminals from which the serial signal is output.

2. A video signal output device comprising:
an HDMI signal processing unit which converts video and audio signals input via two signal paths to a time-division multiplex serial signal and outputs it;
an output selection unit which has a plurality of output terminals and outputs the serial signal input from the HDMI signal processing unit through one of the output terminals which is selected according to a control signal;
a plurality of HDMI terminals each of which is connected to a respective one of the output terminals of the output selection unit; and
a control unit responsive to a command input from a user interface to supply the output selection unit with the control signal to select one of the output terminals from which the serial signal is output.

3. A video signal output device comprising:
a signal producing unit which produces a video signal and an audio signal;
an HDMI signal processing unit which converts the video and audio signals input from the signal producing unit to a time-division multiplex serial signal and outputs it;
an output selection unit which has a plurality of output terminals and outputs the serial signal input from the HDMI signal processing unit through one of the output terminals which is selected according to a control signal; and
a plurality of HDMI terminals each of which is connected to a respective one of the output terminals of the output selection unit.

4. A video signal output device comprising:
a signal producing unit which produces a video signal and an audio signal;
a video and audio signal processing unit which processing the video signal and audio signal input from the signal producing unit;
an HDMI signal processing unit which converts the video and audio signals input from the video and audio signal processing unit to a time-division multiplex serial signal and outputs it;
an output selection unit which has a plurality of output terminals and outputs the serial signal input from the HDMI signal processing unit through one of the output terminals which is selected according to a control signal;
a plurality of HDMI terminals each of which is connected to a respective one of the output terminals of the output selection unit; and
a setting unit which sets a process of the video and audio signal processing unit on a basis of information received from the external equipment.

5. The video output device according to claim 4, wherein EDID is utilized as the information from the external equipment.
